(19) United States
(12) Patent Application Publication
(10) Pub. No.: US 2026/0148592 A1
(43) Pub. Date: May 28, 2026

(54) INTELLIGENT SAFETY MONITORING SYSTEM AND METHOD, AND STORAGE MEDIUM

(71) Applicants: Jingdian (Heyuan) Display Technology Co., Ltd, Heyuan City (CN); Jingdian (Shenzhen) Automotive Technology Co., Ltd, Heyuan City (CN)

(72) Inventors: Ning SU, Heyuan City (CN); Jiaxin SUN, Heyuan City (CN); Chen LIU, Heyuan City (CN); Hanlin JIANG, Heyuan City (CN)

(73) Assignees: Jingdian (Heyuan) Display Technology Co., Ltd, Heyuan City (CN); Jingdian (Shenzhen) Automotive Technology Co., Ltd, Heyuan City (CN)

(21) Appl. No.: 19/249,314

(22) Filed: Jun. 25, 2025

(30) Foreign Application Priority Data
Nov. 22, 2024 (CN) 202411688444.9

(51) Int. Cl. G07C 5/00; G07C 5/08; H04W 4/40; H04W 4/80

(52) U.S. Cl. CPC G07C 5/006; G07C 5/008; G07C 5/0808; G07C 5/0825; H04W 4/40; H04W 4/80

(57) ABSTRACT

Provided are an intelligent safety monitoring system and method. The intelligent safety monitoring system includes: a monitoring unit configured to monitor status information of a vehicle; a control unit connected to the monitoring unit and configured to determine, based on the status information of the vehicle, whether an abnormality occurs on the vehicle; a camera unit connected to the control unit and configured to obtain surrounding environment information of the vehicle based on a control instruction output by the control unit when the control unit determines that the abnormality occurs; and a mobile terminal communicatively connected to the control unit and configured to receive and output the status information of the vehicle and/or an abnormality determination result and the surrounding environment information that are sent by the control unit.

### CROSS-REFERENCE TO RELATED APPLICATION

This patent application claims the benefit and priority of Chinese Patent Application No. 2024116884449, filed with the China National Intellectual Property Administration on Nov. 22, 2024, the disclosure of which is incorporated by reference herein in its entirety as part of the present application.

### TECHNICAL FIELD

The present disclosure relates to the technical field of vehicle monitoring, and in particular, to an intelligent safety monitoring system and method, and a storage medium.

### BACKGROUND

As a technique that senses a physical change in nature and converts the physical change into an electrical signal, a sensor technology is widely applied to various fields, such as automobiles, aviation, healthcare, and smart homes.

In the field of two-wheeled vehicles (hereinafter referred to as “vehicles”), the sensor technology can be employed to monitor a vehicle status such as a parked or riding state, a fuel consumption, and a temperature.

A wireless communication technology is a technique that performs information transmission by means of an electromagnetic wave. The wireless communication technology transmits data collected by a sensor to a control center, or transmits an instruction from the control center to the sensor.

A video surveillance technology is a technique that collects image or video information through a camera device, and performs storage, transmission, and analysis on the image or video information. The video surveillance technology is widely applied in public safety, traffic management, and environmental monitoring, and other fields.

An existing technical solution monitors a status of a vehicle mainly by installing various sensors such as a tire pressure sensor, a vibration sensor, a tilt angle sensor, and a displacement sensor on the vehicle.

These sensors can transmit collected data to a control unit Telematics BOX (T-BOX) of the vehicle, then the T-BOX transmits the collected data to a cloud server through a mobile network (such as a 4th generation mobile communication technology (4G) or 5th generation mobile communication technology (5G) network), and finally the cloud server distributes the corresponding data to an application (APP) on a mobile phone of a user. In this way, the user can view the status of the vehicle on the mobile phone in real time, thereby improving safety of the vehicle.

Although the existing technical solution can monitor the status of the vehicle in real time, there are still some limitations.

Firstly, the existing technical solution mainly relies on the APP on the mobile phone to view the status of the vehicle, but this approach requires the user to constantly pay attention to the mobile phone, which affects user experience to some extent.

Secondly, in the existing technical solution, when the vehicle is unattended, the user may not be informed of any abnormalities such as falling, moving, rolling, or lifting of the vehicle, causing a loss to the vehicle.

Finally, in the existing technical solution, a regulatory platform cannot be connected in a specific environment such as an industrial park, a school, a military, a hospital, or another relatively enclosed place, and as a result, both the user and a regulatory authority cannot grasp the status of the vehicle.

### SUMMARY

An objective of the present disclosure is to provide an intelligent safety monitoring system and method, and a storage medium, to automatically monitor an abnormality of a vehicle and notify a user of the abnormality in a timely manner to reduce a loss, and automatically connect to a regulatory platform in a specific environment.

To achieve the above objective, the present disclosure provides following technical solutions.

According to a first aspect, the present disclosure provides an intelligent safety monitoring system, including:
a monitoring unit configured to monitor status information of a vehicle;
a control unit connected to the monitoring unit and configured to determine, based on the status information of the vehicle, whether an abnormality occurs on the vehicle;
a camera unit connected to the control unit and configured to obtain surrounding environment information of the vehicle based on a control instruction output by the control unit when the control unit determines that the abnormality occurs; and
a mobile terminal communicatively connected to the control unit and configured to receive and output the status information of the vehicle and/or an abnormality determination result and the surrounding environment information that are sent by the control unit.

Preferably, the monitoring unit at least includes one or more of following sensors:
a tire pressure sensor configured to monitor tire pressure information of the vehicle;
a vibration sensor configured to monitor a vibration status of the vehicle;
a tilt angle sensor configured to monitor tilt information of the vehicle;
a displacement sensor configured to monitor a moving status of the vehicle;
a pressure sensor configured to monitor a parked state or a riding state of the vehicle; and
a temperature sensor configured to monitor temperature information of the vehicle; and
the camera unit includes at least one front camera and at least one back camera.

Preferably, the intelligent safety monitoring system further includes:
a monitoring startup unit configured to control the monitoring unit to start monitoring when the vehicle meets a preset condition, where
the preset condition includes at least one of following conditions:
the vehicle is in a locked state;
the vehicle is in a power-off state; and
the vehicle is in an unattended state.

Preferably, that the mobile terminal is communicatively connected to the control unit includes:
the mobile terminal is connected to the control unit through near-field communication, where the near-field communication includes but is not limited to Bluetooth communication, wireless fidelity (WiFi) communication, and StarFlash communication; and/or
the mobile terminal is connected to the control unit through mobile communication, where the mobile communication includes but is not limited to 2nd generation mobile communication technology (2G) communication, 3rd generation mobile communication technology (3G) communication, 4G communication, and 5G communication.

Preferably, the control unit is further configured to: when a preset communication network is detected, connect to a regulatory platform based on a preset communication signal, and send the status information of the vehicle and/or the abnormality determination result and the surrounding environment information to the regulatory platform.

According to a second aspect, the present disclosure provides an intelligent safety monitoring method, including:
monitoring and obtaining status information of a vehicle;
performing abnormality analysis based on the status information of the vehicle;
when an analysis result indicates presence of an abnormality, obtaining surrounding environment information of the vehicle; and
outputting the status information of the vehicle and/or an abnormality determination result and the surrounding environment information.

Preferably, when the vehicle meets a preset condition, the step of monitoring and obtaining the status information of the vehicle is performed, where
the preset condition includes at least one of following conditions:
the vehicle is in a locked state;
the vehicle is in a power-off state; and
the vehicle is in an unattended state.

Preferably, the status information of the vehicle at least includes one or more of following information:
tire pressure information of the vehicle, vibration information of the vehicle, tilt information of the vehicle, a moving status of the vehicle, and temperature information of the vehicle.

Preferably, the outputting the status information of the vehicle and/or an abnormality determination result and the surrounding environment information includes:
outputting the status information of the vehicle and/or the abnormality determination result and the surrounding environment information to a mobile terminal through near-field communication or mobile communication; and
outputting the status information of the vehicle and/or the abnormality determination result and the surrounding environment information to a regulatory platform through a preset communication network.

According to a third aspect, the present disclosure provides a computer-readable storage medium, storing a computer program, where the computer program is executed by a processor to implement the above intelligent safety monitoring method.

According to a fourth aspect, the present disclosure provides a computer program product, including a computer program or an instruction, where the computer program or the instruction is executed by a processor to implement the above intelligent safety monitoring method.

According to specific embodiments provided in the present disclosure, the present disclosure achieves following technical effects:
1. Improving safety of a vehicle in an unattended state: Through interaction between a plurality of sensors (a tire pressure sensor, a vibration sensor, a tilt angle sensor, a pressure sensor, and a displacement sensor), a camera, and a wireless communication device (which can be used for a vehicle body, a mobile phone, or another wearable device), the present disclosure can trigger the sensor, the camera, and a buzzer in a timely manner in the event of an abnormality such as falling, moving, rolling, or lifting of the vehicle when the vehicle is locked and unattended, and transmits the abnormality to a handheld terminal or the wearable device through a signal, thereby improving the safety of the vehicle in the unattended state.
2. Providing a convenient interaction method: The present disclosure enables interaction between a person, the vehicle, and a device such as the handheld terminal through the sensor and the camera, avoiding inconvenience of a user constantly paying attention to the mobile phone and improving user experience.
3. Providing a standard application programming interface (API) and software development kit (SDK) to support a seamless connection to a regulatory platform in a specific environment, and grasp a status of the vehicle in a timely manner: The present disclosure can be connected to the regulatory platform in the specific environment (such as an industrial park, a school, a military, a hospital, or another relatively enclosed place), allowing the user and a regulatory authority to grasp the status of the vehicle in real time without being present, effectively reducing a loss of the vehicle.
4. Having wide application scenarios: The present disclosure is not only applicable to ordinary two-wheeled vehicles, but also applicable to other special vehicles, with a wide range of application scenarios.
5. Improving communication efficiency: The present disclosure uses a 5G technology for data transmission, which has a higher communication speed and a lower latency compared with an existing 4G technology, thereby improving efficiency and reliability of the data transmission.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and a person of ordinary skill in the art may still derive other accompanying drawings from these accompanying drawings without creative efforts.

FIG. 1 is a schematic structural diagram of an intelligent safety monitoring system according to an embodiment of the present disclosure;

FIG. 2 is a schematic flowchart of an intelligent safety monitoring method according to an embodiment of the present disclosure;

FIG. 3 shows an internal structure of a computer device according to an embodiment of the present disclosure;

FIG. 4 shows an architecture of an intelligent safety monitoring system implemented based on a T-BOX according to an embodiment of the present disclosure;

FIG. 5 shows an architecture of an intelligent safety monitoring system implemented based on a host according to an embodiment of the present disclosure;

FIG. 6 shows an architecture of an intelligent safety monitoring system implemented based on a host and used for short-range transmission according to an embodiment of the present disclosure;

FIG. 7 shows a hardware architecture of an intelligent safety monitoring system implemented based on a host according to an embodiment of the present disclosure;

FIG. 8 shows a hardware architecture of an intelligent safety monitoring system implemented based on a T-BOX according to an embodiment of the present disclosure;

FIG. 9 shows a hardware architecture of an intelligent safety monitoring system implemented based on a host according to an embodiment of the present disclosure; and

FIG. 10 shows a hardware architecture of an intelligent safety monitoring system implemented based on a T-BOX according to an embodiment of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure more obvious and easy to understand, the present disclosure will be further described in detail with reference to the accompanying drawings and specific implementations.

### Embodiment 1

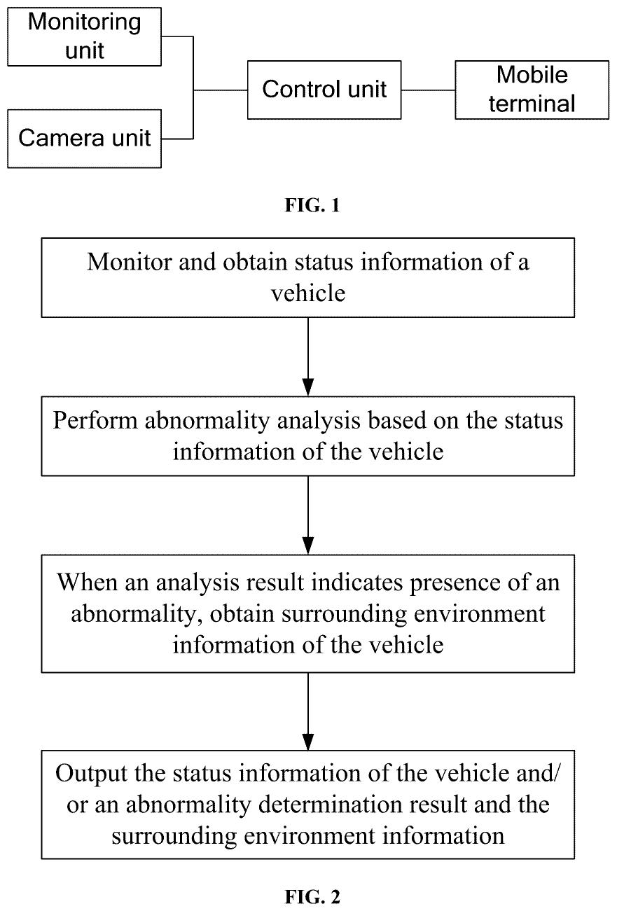

As shown in FIG. 1, the present disclosure provides an intelligent safety monitoring system, including:
a monitoring unit configured to monitor status information of a vehicle;
a control unit connected to the monitoring unit and configured to determine, based on the status information of the vehicle, whether an abnormality occurs on the vehicle;
a camera unit connected to the control unit and configured to obtain surrounding environment information of the vehicle based on a control instruction output by the control unit when the control unit determines that the abnormality occurs; and
a mobile terminal communicatively connected to the control unit and configured to receive and output the status information of the vehicle and/or an abnormality determination result and the surrounding environment information that are sent by the control unit.

In this embodiment of the present disclosure, in order to enable a user to conveniently understand information of the abnormality of the vehicle at any time, the monitoring unit is disposed in the vehicle in the solutions of the present disclosure to monitor the status information of the vehicle. For example, information of the vehicle is monitored, including battery level information, tire pressure information, position information, mileage information, indicator information such as headlight/turn signal indicator information and warning light/malfunction indicator information, and a parking status. For example, side support, main support, temperature information of the vehicle, and information on whether the vehicle is in a parked state or a riding state are monitored.

In one embodiment, when the status information of the vehicle is monitored, specifically, the monitoring unit is connected to a power chip of the vehicle to obtain the battery level information of the vehicle. A tire pressure sensor in the monitoring unit is disposed on a tire of the vehicle to monitor the tire pressure information of the tire of the vehicle. A vibration sensor in the monitoring unit is disposed on a frame of the vehicle to monitor vibration information of the vehicle. A displacement sensor in the monitoring unit is disposed on the vehicle to monitor moving information of the vehicle. A positioning module in the monitoring unit is disposed on the vehicle to monitor and obtain the position information of the vehicle. A tilt angle sensor in the monitoring unit is disposed on the vehicle to monitor and obtain the parking status of the vehicle. A temperature sensor in the monitoring unit is disposed on the vehicle to monitor and obtain the temperature information of the vehicle. A pressure sensor in the monitoring unit is disposed on a handlebar and/or a seat cushion of the vehicle to monitor the user's gripping force on the handlebar or pressure on the seat cushion, so as to determine the parked state or the riding state of the vehicle.

The monitored status information of the vehicle is sent to the control unit for analysis on the abnormality of the vehicle. After the analysis, the control unit determines that the abnormality occurs on the vehicle. In this embodiment of the present disclosure, when a battery level of the vehicle is less than a preset battery level, for example, when a current battery level is less than 20% of a total battery level, it is determined through the analysis that there is an abnormality in the battery level. When it is monitored that air pressure of the tire of the vehicle is less than first preset air pressure or greater than second preset air pressure, for example, when the air pressure of the tire is less than 1.8 bars or greater than 3.0 bars, it is determined that there is an abnormality in the air pressure of the tire of the vehicle. When it is monitored that the vehicle moves in the parked state, it is determined that there is an abnormality in the position information of the vehicle. Furthermore, when a moving distance of the vehicle is greater than a preset distance, for example, when the moving distance is 500 meters, which is greater than a preset distance of 2 meters, it is determined that there is an abnormality in a mileage of the vehicle. When it is monitored that a headlight or a turn signal indicator of the vehicle is on in the parked state, it is determined that there is an abnormality in the headlight or the turn signal indicator. When it is monitored that a warning light or a malfunction indicator of the vehicle is on in the parked state, it is determined that there is an abnormality in the warning light or the malfunction indicator. When it is monitored that a tilt angle of the vehicle reaches a preset angle, for example, when the tilt angle is 0 degrees, it is determined that the vehicle is in a main support state. When it is monitored that the tilt angle is greater than 0 degrees but less than 45 degrees, it is determined that the vehicle is in a side support state. When it is monitored that the tilt angle is greater than 45 degrees, it is determined that the vehicle is in a fallen state and it is determined that there is an abnormality. When it is monitored that a temperature is greater than a preset value, for example, when it is detected that the temperature is 100° C., which is greater than preset 50° C., it is determined that the vehicle is in a high-temperature abnormal state. Furthermore, the camera unit is controlled to be started to obtain the surrounding environment information of the vehicle. In this embodiment of the present disclosure, the camera unit includes a front camera and a back camera. The front camera is used to obtain information in a front direction of the vehicle, while the back camera is used to obtain information in a rear direction of the vehicle. For example, during driving of the vehicle, the front and back cameras are used to capture and record road traffic conditions, including a driving status and a traffic violation of the vehicle. When the vehicle is in the parked state, a parking environment is captured by the front and back cameras. For another example, when it is detected that the pressure sensor on the handlebar of the vehicle receives gripping force information or the pressure sensor on the seat cushion of the vehicle receives pressure information when the vehicle is in the parked state, it is determined that the abnormality occurs on the vehicle. Furthermore, the monitored status information of the vehicle and/or the abnormality determination result and the surrounding environment information that is of the vehicle and obtained by the camera unit are transmitted to the user's mobile terminal through a mobile communication network or a near-field communication network. For example, the monitored status information of the vehicle and/or the abnormality analysis result and the surrounding environment information that is of the vehicle and obtained by the camera unit are transmitted to the user's smartphone through a 5G mobile network for easy viewing by the user. For example, the monitored status information of the vehicle and/or the abnormality analysis result and the surrounding environment information that is of the vehicle and obtained by the camera unit are transmitted to the user's smartphone through Bluetooth, WiFi, StarFlash, and other communication. In another implementation, the monitored status information of the vehicle and/or the abnormality analysis result and the surrounding environment information that is of the vehicle and obtained by the camera unit are transmitted to a cloud server. Based on identification information of the user, the cloud server further sends the monitored status information of the vehicle and/or the abnormality analysis result and the surrounding environment information that is of the vehicle and obtained by the camera unit to the user's mobile terminal. The user understands a safety status of the vehicle, the surrounding environment information of the vehicle, and the like in a timely manner through the mobile terminal. In this embodiment, when determining through the analysis that the abnormality occurs on the vehicle, the control unit also triggers an alarm to notify the user, for example, triggers a buzzer to emit an alarm sound.

In this embodiment of the present disclosure, in order to accurately monitor the status information of the vehicle, precise working parameters are set for each sensor in the monitoring unit to complete status monitoring of the vehicle. For example, a measurement range of the tire pressure sensor is set to 0 bars to 10 bars, with an accuracy of ±0.5 bars and a working temperature of −40° C. to 85° C. A measurement range of the vibration sensor is set to 0 g to 100 g, with an accuracy of ±0.5 g and a working temperature of −40° C. to 85° C. A measurement range of the tilt angle sensor is set to 0 degrees to 360 degrees, with an accuracy of ±0.5 degrees and a working temperature of −40° C. to 85° C. A measurement range of the displacement sensor is set to 0 cm to 100 cm, with an accuracy of ±0.5 cm and a working temperature of −40° C. to 85° C. A measurement range of the temperature sensor is set to 0° C. to 99° C.

In one embodiment, in order to clearly obtain the surrounding environment information of the vehicle, a high-configuration camera unit is disposed in the intelligent safety monitoring system. For example, working parameters of the camera unit are set as follows: Resolution is set to 1080 p, a frame rate is set to 30 fps, a horizontal viewing angle is set to 120 degrees, and a working temperature is set to −20° C. to 60° C. With the high-configuration camera unit, a change in the surrounding environment information of the vehicle can be clearly monitored when the abnormality occurs on the vehicle.

In this embodiment of the present disclosure, a monitoring startup unit of the intelligent safety monitoring system is further disposed on the vehicle to control the monitoring unit to start a monitoring function when determining that the vehicle meets a preset condition. For example, when detecting that the user has locked the vehicle, in other words, when the vehicle is in a locked state, the monitoring startup unit controls the monitoring unit to start the monitoring function. For another example, when detecting that the user has turned off a power supply of the vehicle and stopped supplying power to the vehicle, the monitoring startup unit controls the monitoring unit to start the monitoring function. For another example, when detecting that the vehicle is in an unattended state, the monitoring startup unit controls the monitoring unit to start the monitoring function. In this embodiment, the above preset condition is only illustrative. Based on the concept of the present disclosure, other preset conditions all fall within the protection scope of the present disclosure and will not be described herein.

In this embodiment of the present disclosure, the mobile terminal is used by the user to remotely receive and view the status information of the vehicle and/or the abnormality determination result and the surrounding environment information of the vehicle that are sent by the intelligent safety monitoring system. Therefore, the mobile terminal is communicatively connected to the control unit of the intelligent safety monitoring system to facilitate information transmission. In one embodiment, the mobile terminal is connected to the control unit of the intelligent safety monitoring system through near-field communication, such as Bluetooth communication, WiFi communication, StarFlash communication, or infrared communication. In another embodiment, the mobile terminal is connected to the control unit of the intelligent safety monitoring system through mobile communication, such as 2G communication, 3G communication, 4G communication, or 5G communication. In this embodiment, when the mobile terminal is communicatively connected to the intelligent safety monitoring system, the near-field communication and the mobile communication may be used simultaneously for the communicative connection, one of the near-field communication and the mobile communication may be selected for the communicative connection based on the user's operation; or the near-field communication and the mobile communication may be selected based on a priority of a communication network, for example, the mobile communication has a highest priority, followed by the near-field communication. In this embodiment, the priority of the communication network will also dynamically change with an environment. For example, when the vehicle is parked in an environment without a mobile communication signal, the mobile terminal is communicatively connected to the intelligent safety monitoring system through the near-field communication. In this embodiment of the present disclosure, the mobile terminal may be a smartphone, a tablet computer, a smartwatch, a smart wristband, or the like of the user. Any portable terminal that can be used by the user to conveniently view the status information of the vehicle and/or the abnormality determination result and the surrounding environment information of the vehicle can be considered as the mobile terminal, and there is no specific restriction on the mobile terminal.

In this embodiment, the mobile terminal saves the status information of the vehicle and/or the abnormality determination result and the surrounding environment information of the vehicle that are sent by the control unit, for subsequent analysis and processing.

In this embodiment of the present disclosure, the intelligent safety monitoring system in the present disclosure provides a standard API and SDK to support a seamless connection to a regulatory platform in a specific environment. When the user parks the vehicle in a specific area, such as an industrial park, a school, a military, a hospital, or another relatively enclosed place, the control unit of the intelligent safety monitoring system connects to a regulatory platform through WiFi, Bluetooth, StarFlash, or the like provided by the relatively enclosed place, and sends the monitored status information of the vehicle to the regulatory platform for monitoring and management. In this embodiment, when detecting specific WiFi or Bluetooth, the control unit of the vehicle can determine that the user parks the vehicle in a specific area, such as the industrial park, the school, the military, the hospital, or the another relatively enclosed place. The control unit then connects to the regulatory platform through the detected specific WiFi or Bluetooth to monitor the status information of the vehicle. In this embodiment, through the regulatory platform, the user and a regulatory authority can grasp a status of the vehicle in real time without being present, thereby effectively reducing a loss of the vehicle.

### Embodiment 2

As shown in FIG. 2, the present disclosure provides an intelligent safety monitoring method, including:
monitoring and obtaining status information of a vehicle;
performing abnormality analysis based on the status information of the vehicle;
when an analysis result indicates presence of an abnormality, obtaining surrounding environment information of the vehicle; and
outputting the status information of the vehicle and/or an abnormality determination result and the surrounding environment information.

In this embodiment of the present disclosure, in order to enable a user to conveniently understand a safety status of the vehicle in a timely manner, when safety of the vehicle is monitored, the corresponding status information of the vehicle is first obtained by monitoring the vehicle, such as battery level information, tire pressure information, position information, mileage information, indicator information such as headlight/turn signal indicator information, warning light/malfunction indicator information, a parking status such as side support or main support, temperature information, and information about whether the vehicle is in a parked state or a riding state. Furthermore, the obtained status information of the vehicle is analyzed to determine whether the abnormality occurs on the vehicle. In this embodiment of the present disclosure, when a battery level of the vehicle is less than a preset battery level, for example, when a current battery level is less than 20% of a total battery level, it is determined through the analysis that there is an abnormality in the battery level. When it is monitored that air pressure of a tire of the vehicle is less than first preset air pressure or greater than second preset air pressure, for example, when the air pressure of the tire is less than 1.8 bars or greater than 3.0 bars, it is determined through the analysis that there is an abnormality in the air pressure of the tire of the vehicle. When it is monitored that the vehicle moves in the parked state, it is determined that there is an abnormality in the position information of the vehicle. Furthermore, when a moving distance of the vehicle is greater than a preset distance, for example, is 500 meters, it is determined that there is an abnormality in a mileage of the vehicle. When it is monitored that a headlight or a turn signal indicator of the vehicle is on in the parked state, it is determined that there is an abnormality in the headlight or the turn signal indicator. When it is monitored that a warning light or a malfunction indicator of the vehicle is on in the parked state, it is determined that there is an abnormality in the warning light or the malfunction indicator. For another example, when it is monitored that a tilt angle of the vehicle reaches a preset angle, for example, when the tilt angle is 0 degrees, it is determined that the vehicle is in a main support state. When it is monitored that the tilt angle is greater than 0 degrees but less than 45 degrees, it is determined that the vehicle is in a side support state. When it is monitored that the tilt angle is greater than 45 degrees, it is determined that the vehicle is in a fallen state and it is determined that there is an abnormality. For another example, when it is monitored that a temperature is greater than a preset value, for example, is 100° C., it is determined that the vehicle is in a high-temperature abnormal state. Furthermore, control is performed to obtain the surrounding environment information of the vehicle. For example, information about flowers, trees, pedestrians, shops, and the like around the vehicle is obtained through front and back cameras disposed on the vehicle. Furthermore, the monitored status information of the vehicle and/or the abnormality determination result and the surrounding environment information that is of the vehicle and obtained by the camera are transmitted to the user's mobile terminal through a mobile communication network or a near-field communication network. For example, the monitored status information of the vehicle and/or the abnormality analysis result and the surrounding environment information that is of the vehicle and obtained by a camera unit are transmitted to the user's smartphone through a 5G mobile network, such that the user can understand in a timely manner whether the vehicle is safe. For another example, the monitored status information of the vehicle and/or the abnormality analysis result and the surrounding environment information that is of the vehicle and obtained by the camera unit are transmitted to the user's smartphone through Bluetooth, WiFi, StarFlash, and other near-field communication. In one embodiment of the present disclosure, the status information of the vehicle and/or the abnormality determination result and the surrounding environment information are transmitted to a cloud server through near-field communication such as the WiFi communication, the Bluetooth communication, or the StarFlash communication and/or through mobile communication such as 3G communication, 4G communication, or 5G communication. Based on identification information of the user, the cloud server further sends the monitored status information of the vehicle and/or the abnormality analysis result and the surrounding environment information that is of the vehicle and obtained by the camera unit to the user's mobile terminal. In another embodiment, when the vehicle enters a specific environment, the status information of the vehicle and/or the abnormality determination result and the surrounding environment information are also output to a corresponding regulatory platform of the specific environment through a preset communication network such as a specific WiFi, Bluetooth, or StarFlash network.

In this embodiment of the present disclosure, when the vehicle is always in a monitored state, a large amount of data will be generated, which may cause the mobile terminal to continuously receive data information, resulting in insufficient traffic. As a result, due to the insufficient traffic or an insufficient cost, the mobile terminal may be unable to receive the status information of the vehicle or the abnormality determination result and the surrounding environment information obtained by the camera. Therefore, in order to enhance necessity of monitoring and save traffic or a cost for the user, some conditions are preset. When the vehicle meets at least one of the preset conditions, the vehicle is monitored and the status information of the vehicle is obtained. The preset conditions may be that the vehicle is in a locked state, the vehicle is in a power-off state, or the vehicle is in an unattended state; or may be another condition, which will not be elaborated herein. However, other conditions based on the above concept all fall within the protection scope of the present disclosure.

### Embodiment 3

This embodiment of the present disclosure provides a computer-readable storage medium, storing a computer program thereon. The computer program is executed by a processor to implement the above intelligent safety monitoring method. In this embodiment, the computer-readable storage medium may be a storage medium of a mobile phone, a storage medium of a tablet, a storage medium of a wearable product, or a storage medium of a personal computer (PC). This is not specifically limited in the present disclosure, and all are within the protection scope of the present disclosure.

### Embodiment 4

This embodiment provides a computer program product, including a computer program or an instruction. The computer program or the instruction is executed by a processor to implement the intelligent safety monitoring method in Embodiment 2. In this embodiment, the computer program product may be a program product running on a mobile phone, a program product running on a tablet, a program product running on a wearable product such as a smart wristband or a smartwatch, or a program product running on a PC. This is not specifically limited in the present disclosure, and all are within the protection scope of the present disclosure.

### Embodiment 5

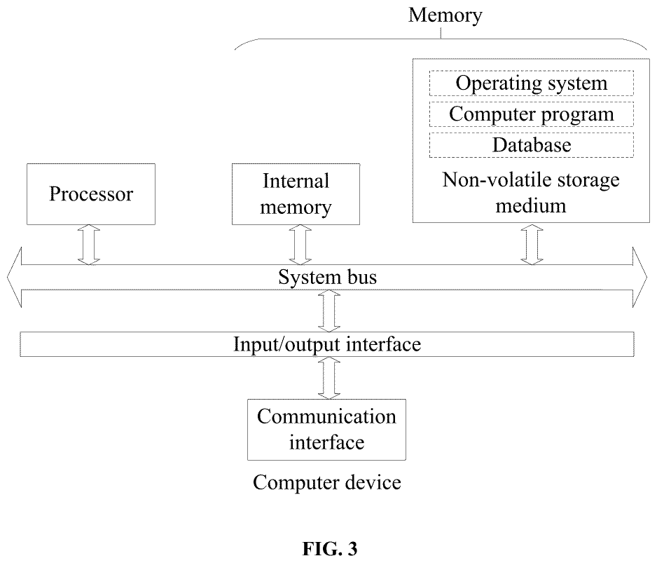

The present disclosure provides a computer device. The computer device may be a database and may have an internal structure shown in FIG. 3. The computer device includes a processor, a memory, an input/output (I/O) interface, and a communication interface. The processor, the memory, and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running the operating system and the computer program in the non-volatile storage medium. The database of the computer device is configured to store a pending transaction. The I/O interface of the computer device is configured to exchange information between the processor and an external device. The communication interface of the computer device is configured to connect to and communicate with an external terminal through a network. The computer program is executed by the processor to implement the intelligent safety monitoring method in Embodiment 2.

It should be noted that information of an object (including but not limited to device information of the object, personal information of the object, and the like) and data (including but not limited to data for analysis, data for storage, data for exhibition, and the like) in the present disclosure are information and data authorized by the object or fully authorized by each party, and relevant data shall be acquired, used, and processed according to laws, regulations, and standards of related countries and regions.

Those of ordinary skill in the art may understand that all or some of the procedures in the method of the foregoing embodiments may be implemented by a computer program instructing related hardware. The computer program may be stored in a non-volatile computer-readable storage medium. When the computer program is executed, the procedures in the embodiments of the above method may be performed. Any reference to a memory, a database, or other media used in the embodiments of the present disclosure may include at least one of a non-volatile memory and a volatile memory. The non-volatile memory may include an embedded multi-media card (eMMC), a universal flash storage (UFS), a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. As an illustration rather than a limitation, the RAM may be in various forms, such as a static random access memory (SRAM) or a dynamic random access memory (DRAM). The database in the embodiments of the present disclosure may include at least one of a relational database and a non-relational database. The non-relational database may include a blockchain-based distributed database, but is not limited thereto. The processor in the embodiments of the present disclosure may be a general processor, a central processing unit, a graphics processor, a digital signal processor, a programmable logic device, and a data processing logic device based on quantum computing, but is not limited thereto.

### Embodiment 6

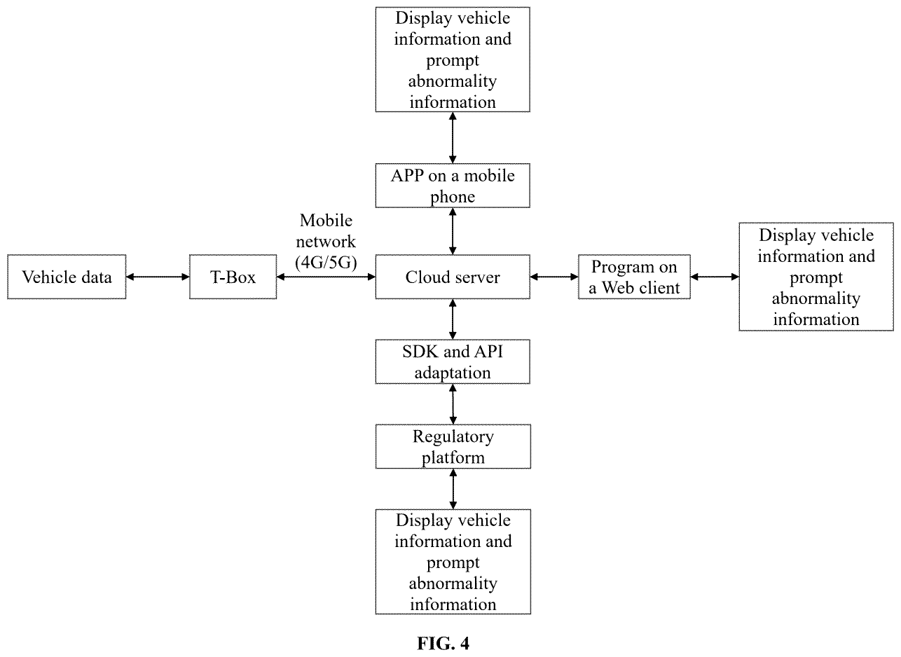

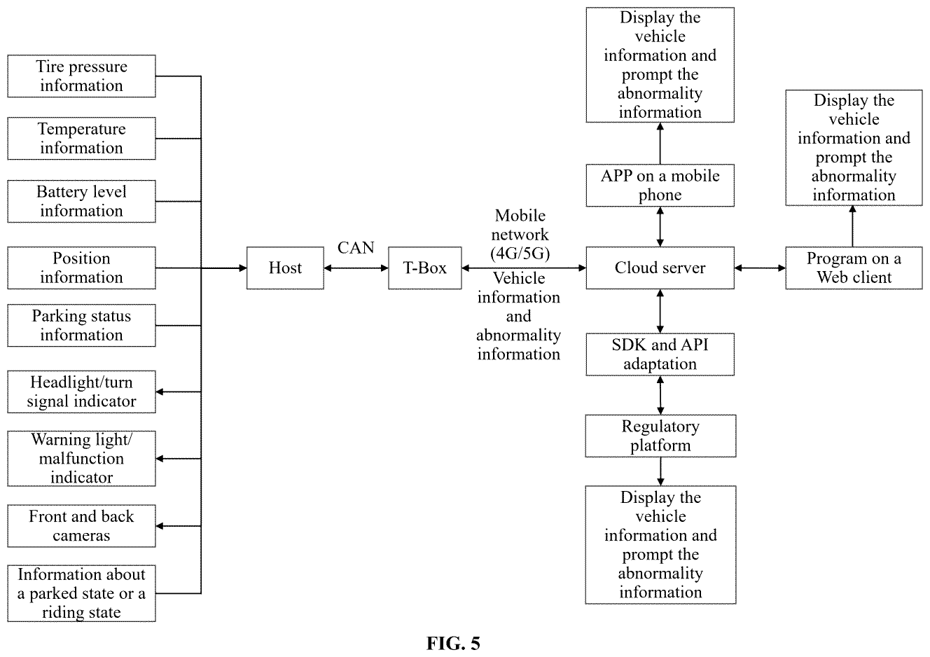

As shown in FIG. 4, the present disclosure provides an intelligent safety monitoring software method implemented based on a T-BOX. Information of a vehicle is obtained through the T-BOX, including tire pressure information, temperature information, battery level information, position information, an on or off state of a headlight/a turn signal indicator, an on or off state of a warning light/a malfunction indicator, real-scene photo data obtained by front and back cameras during parking and moving, a parked state such as side support, main support, or other abnormal parking, and a riding state, and information data about an abnormal state is analyzed based on the obtained information of the vehicle, and sent by the T-BOX to a back end of a built cloud server through a mobile network (5G/4G) for reception. The cloud server sends the information data about the abnormal state to a program on a mobile phone and a web client to display real-time data information of the vehicle and prompt a user to handle abnormality information of the vehicle. The present disclosure provides a standard SDK and API. A third-party regulatory platform can adapt to a corresponding interface to receive data information and abnormality information of the vehicle in real time, and prompt the user to take a corresponding action.

### Embodiment 7

As shown in FIG. 5, the present disclosure provides an intelligent safety monitoring software method implemented based on a host. The host obtains information of a vehicle, including tire pressure information, temperature information, battery level information, position information, an on or off state of a headlight/a turn signal indicator, an on or off state of a warning light/a malfunction indicator, real-scene photo data obtained by front and back cameras during parking and moving, a parked state such as side support, main support, or other abnormal parking, and a riding state. After abnormality analysis, the host sends the obtained information of the vehicle and information data about an abnormal state to a T-BOX through a controller area network (CAN) bus, and then the data is sent to a back end of a built cloud server through a mobile network (5G/4G) of the T-BOX for reception. The cloud server sends the data to a program on a mobile phone and a web client to display real-time data information of the vehicle and prompt a user to handle abnormality information of the vehicle. The present disclosure provides a standard SDK and API. A third-party regulatory platform can adapt to a corresponding interface to receive data information and abnormality information of the vehicle in real time, and prompt the user to take a corresponding action.

### Embodiment 8

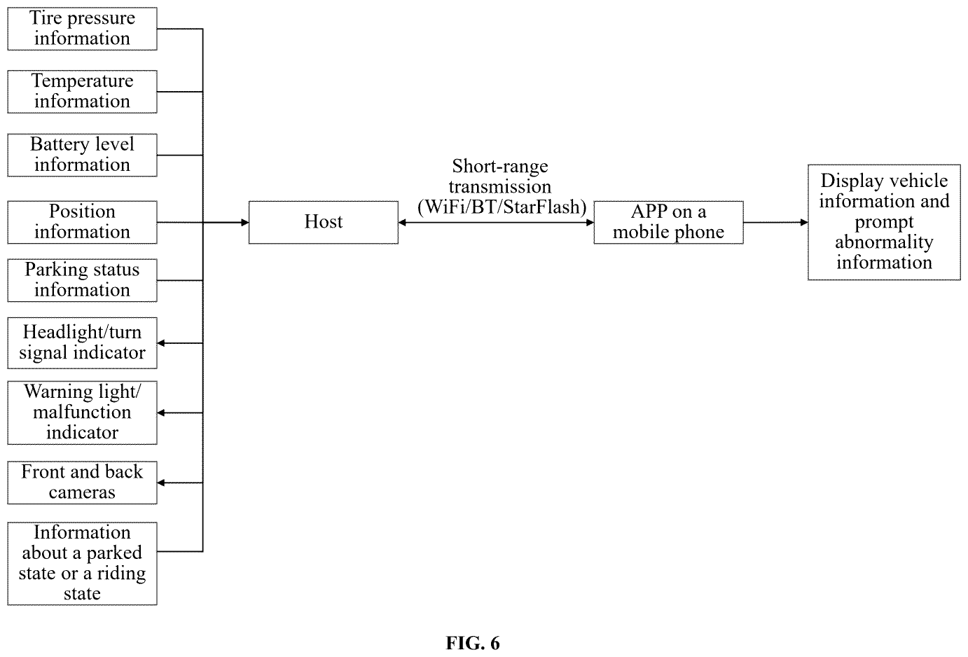

As shown in FIG. 6, the present disclosure provides a software design method for short-range transmission of intelligent safety monitoring and implemented based on a host. The host connects to and communicates with an APP on a mobile phone through WiFi, Bluetooth (including Bluetooth low energy (BLE)), or StarFlash. The mobile phone receives information of a vehicle, including tire pressure information, temperature information, battery level information, position information, an on or off state of a headlight/a turn signal indicator, an on or off state of a warning light/a malfunction indicator, real-scene photo data obtained by front and back cameras during parking and moving, a parked state such as side support, main support, or other abnormal parking, and a riding state. The APP on the mobile phone receives data information of the vehicle, identifies abnormality information, and prompts a user to take a corresponding action.

### Embodiment 9

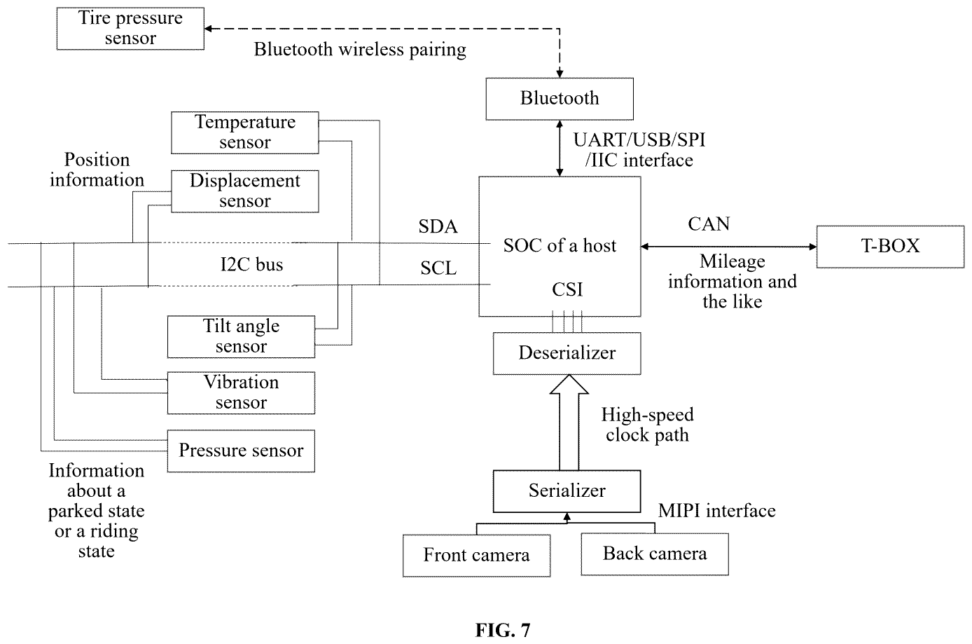

As shown in FIG. 7, the present disclosure provides a hardware design for an intelligent safety monitoring system implemented based on a host. A temperature sensor, a displacement sensor, a tilt angle sensor, a vibration sensor, and a pressure sensor are connected to serial data (SDA) and serial clock (SCL) buses corresponding to a system on chip (SOC) of the host through an inter-integrated circuit (I2C) bus. A tire pressure sensor and a Bluetooth module (including a universal asynchronous receiver/transmitter (UART) interface/universal serial bus (USB) interface/a serial peripheral interface (SPI)/an IIC interface) of the host are automatically paired and connected through Bluetooth by default. Front and back cameras of a mobile industry processor interface (MIPI) are connected to a camera serial interface (CSI) of the SOC of the host through a serializer and a deserializer. The SOC of the host communicates with a T-BOX through a CAN bus.

### Embodiment 10

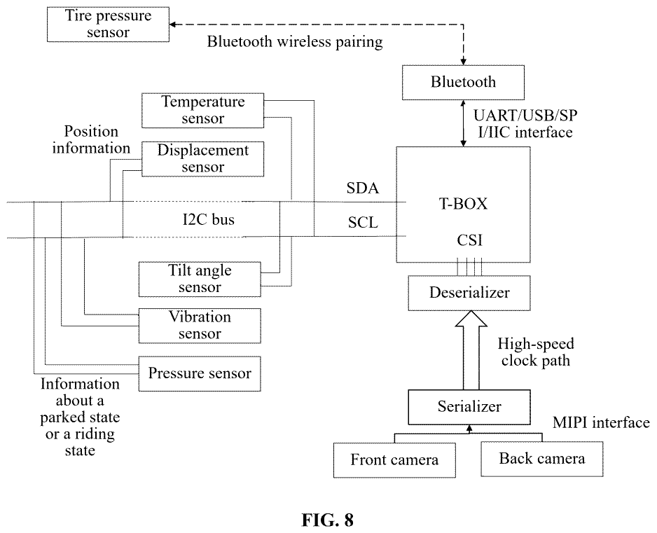

As shown in FIG. 8, the present disclosure provides a hardware design for an intelligent safety monitoring system implemented based on a T-BOX. A temperature sensor, a displacement sensor, a tilt angle sensor, a vibration sensor, and a pressure sensor are connected to SDA and SCL buses corresponding to a SOC of a host through an I2C bus. A tire pressure sensor and a Bluetooth module (including a UART interface/a USB interface/an SPI/an IIC interface) of the T-BOX are automatically paired and connected through Bluetooth by default. Front and back cameras of an MIPI are connected to a CSI of the T-BOX through a serializer and a deserializer.

### Embodiment 11

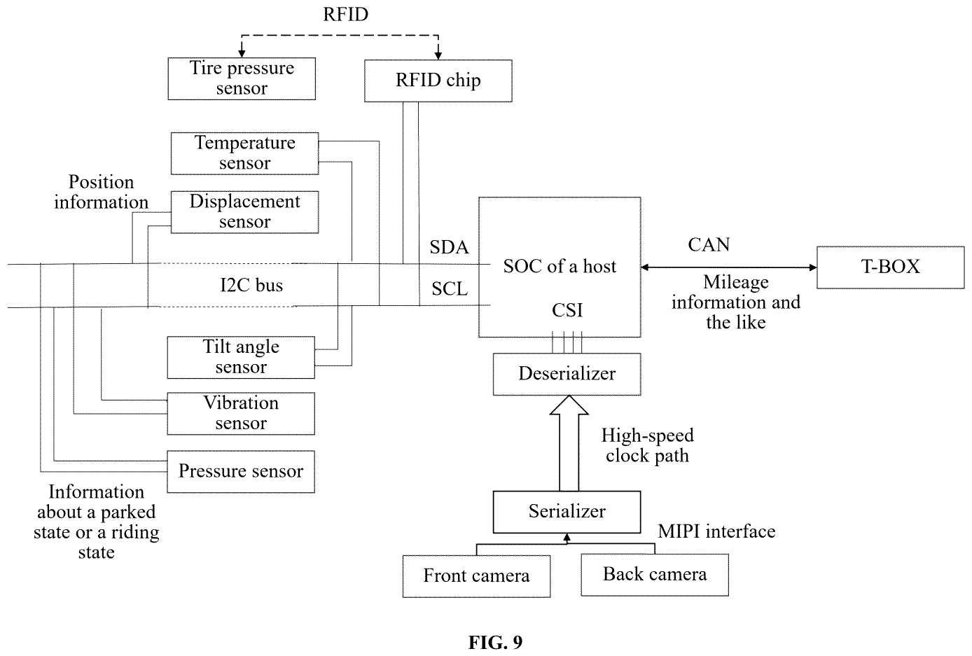

As shown in FIG. 9, the present disclosure provides a hardware design for an intelligent safety monitoring system implemented based on a host. A temperature sensor, a displacement sensor, a tilt angle sensor, a vibration sensor, and a pressure sensor are connected to SDA and SCL buses corresponding to a SOC of the host through an I2C bus. A tire pressure sensor communicates with a radio frequency identification (RFID) chip of the host through RFID to obtain tire pressure information. Front and back cameras of an MIPI are connected to a CSI of the SOC of the host through a serializer and a deserializer. The SOC of the host communicates with a T-BOX through a CAN bus.

### Embodiment 12

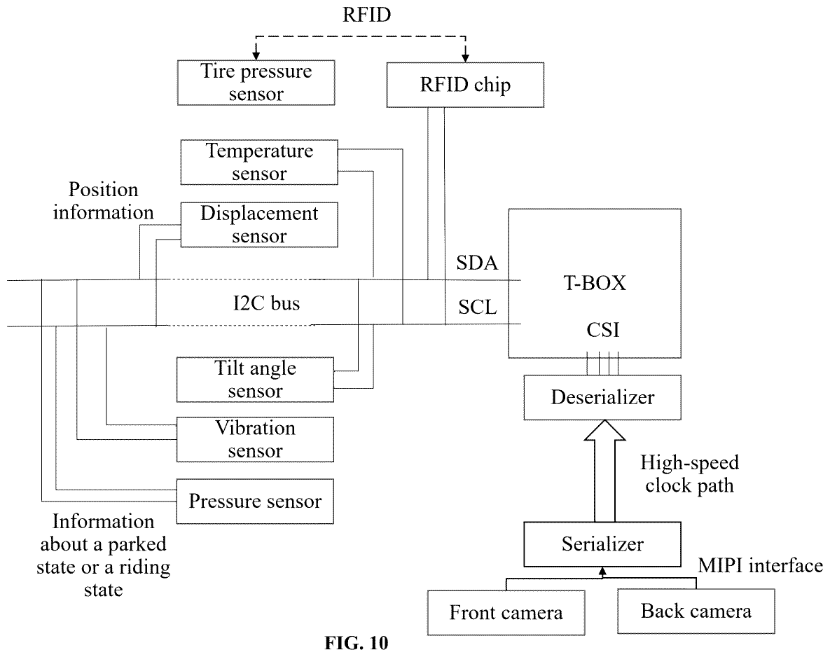

As shown in FIG. 10, the present disclosure provides a hardware design for an intelligent safety monitoring system implemented based on a T-BOX. A temperature sensor, a displacement sensor, a tilt angle sensor, a vibration sensor, a pressure sensor, and an RFID chip are connected to SDA and SCL buses corresponding to the T-BOX through an I2C bus. A tire pressure sensor communicates with an RFID chip of a host through RFID to obtain tire pressure information. Front and back cameras of an MIPI are connected to a CSI of the T-BOX through a serializer and a deserializer.

The technical characteristics of the above embodiments can be employed in arbitrary combinations. For brevity of description, all possible combinations of all the technical characteristics of the above embodiments may not be described; however, these combinations of the technical characteristics should be construed as falling within the scope defined by this specification as long as no contradiction occurs.

Several examples are used herein for illustration of the principles and implementations of the present disclosure. The description of the above embodiments is only used to help illustrate the method of the present disclosure and the core principles thereof. In addition, those of ordinary skill in the art can make various modifications in terms of specific implementations and scope of application in accordance with the teachings of the present disclosure. In conclusion, the content of this specification shall not be construed as a limitation to the present disclosure.

What is claimed is:

1. An intelligent safety monitoring system, comprising:
a monitoring unit configured to monitor status information of a vehicle;
a control unit connected to the monitoring unit and configured to determine, based on the status information of the vehicle, whether an abnormality occurs on the vehicle;
a camera unit connected to the control unit and configured to obtain surrounding environment information of the vehicle based on a control instruction output by the control unit when the control unit determines that the abnormality occurs; and
a mobile terminal communicatively connected to the control unit and configured to receive and output the status information of the vehicle and/or an abnormality determination result and the surrounding environment information that are sent by the control unit.

2. The intelligent safety monitoring system according to claim 1, wherein the monitoring unit at least comprises one or more of following sensors:
a tire pressure sensor configured to monitor tire pressure information of the vehicle;
a vibration sensor configured to monitor a vibration status of the vehicle;
a tilt angle sensor configured to monitor tilt information of the vehicle;
a pressure sensor configured to monitor a parked state or a riding state of the vehicle;
a displacement sensor configured to monitor a moving status of the vehicle; and
a temperature sensor configured to monitor temperature information of the vehicle; and
the camera unit comprises at least one front camera and at least one back camera.

3. The intelligent safety monitoring system according to claim 1, further comprising:
a monitoring startup unit configured to control the monitoring unit to start monitoring when the vehicle meets a preset condition, wherein
the preset condition comprises at least one of following conditions:
the vehicle is in a locked state;
the vehicle is in a power-off state; and
the vehicle is in an unattended state.

4. The intelligent safety monitoring system according to claim 1, wherein that the mobile terminal is communicatively connected to the control unit comprises:
the mobile terminal is connected to the control unit through near-field communication, wherein the near-field communication comprises but is not limited to Bluetooth communication, wireless fidelity (WiFi) communication, and StarFlash communication; and/or
the mobile terminal is connected to the control unit through mobile communication, wherein the mobile communication comprises but is not limited to 2nd generation mobile communication technology (2G) communication, 3rd generation mobile communication technology (3G) communication, 4th generation mobile communication technology (4G) communication, and 5th generation mobile communication technology (5G) communication.

5. The intelligent safety monitoring system according to claim 1, wherein
the control unit is further configured to: when a preset communication network is detected, connect to a regulatory platform based on a preset communication signal, and send the status information of the vehicle and/or the abnormality determination result and the surrounding environment information to the regulatory platform.

6. An intelligent safety monitoring method, comprising:
monitoring and obtaining status information of a vehicle;
performing abnormality analysis based on the status information of the vehicle;
when an analysis result indicates presence of an abnormality, obtaining surrounding environment information of the vehicle; and
outputting the status information of the vehicle and/or an abnormality determination result and the surrounding environment information.

7. The intelligent safety monitoring method according to claim 6, wherein when the vehicle meets a preset condition, the monitoring and obtaining the status information of the vehicle is performed, wherein
the preset condition comprises at least one of following conditions:
the vehicle is in a locked state;
the vehicle is in a power-off state; and
the vehicle is in an unattended state.

8. The intelligent safety monitoring method according to claim 6, wherein the status information of the vehicle at least comprises one or more of following information;
tire pressure information of the vehicle, vibration information of the vehicle, tilt information of the vehicle, a moving status of the vehicle, and temperature information of the vehicle.

9. The intelligent safety monitoring method according to claim 6, wherein the outputting the status information of the vehicle and/or an abnormality determination result and the surrounding environment information comprises:
outputting the status information of the vehicle and/or the abnormality determination result and the surrounding environment information to a mobile terminal through near-field communication or mobile communication; and
outputting the status information of the vehicle and/or the abnormality determination result and the surrounding environment information to a regulatory platform through a preset communication network.

10. A non-transitory computer-readable storage medium, storing a computer program, wherein the computer program is executed by a processor to implement the intelligent safety monitoring method according to any one of claim 6.

11. The intelligent safety monitoring system according to claim 2, wherein
the control unit is further configured to: when a preset communication network is detected, connect to a regulatory platform based on a preset communication signal, and send the status information of the vehicle and/or the abnormality determination result and the surrounding environment information to the regulatory platform.

12. The intelligent safety monitoring system according to claim 3, wherein
the control unit is further configured to: when a preset communication network is detected, connect to a regulatory platform based on a preset communication signal, and send the status information of the vehicle and/or the abnormality determination result and the surrounding environment information to the regulatory platform.

13. The intelligent safety monitoring system according to claim 4, wherein
the control unit is further configured to: when a preset communication network is detected, connect to a regulatory platform based on a preset communication signal, and send the status information of the vehicle and/or the abnormality determination result and the surrounding environment information to the regulatory platform.

14. The intelligent safety monitoring method according to claim 7, wherein the status information of the vehicle at least comprises one or more of following information;
tire pressure information of the vehicle, vibration information of the vehicle, tilt information of the vehicle, a moving status of the vehicle, and temperature information of the vehicle.

15. The intelligent safety monitoring method according to claim 7, wherein the outputting the status information of the vehicle and/or an abnormality determination result and the surrounding environment information comprises:
outputting the status information of the vehicle and/or the abnormality determination result and the surrounding environment information to a mobile terminal through near-field communication or mobile communication; and
outputting the status information of the vehicle and/or the abnormality determination result and the surrounding environment information to a regulatory platform through a preset communication network.

16. A non-transitory computer-readable storage medium, storing a computer program, wherein the computer program is executed by a processor to implement the intelligent safety monitoring method according to any one of claim 7.

17. A non-transitory computer-readable storage medium, storing a computer program, wherein the computer program is executed by a processor to implement the intelligent safety monitoring method according to any one of claim 8.

18. A non-transitory computer-readable storage medium, storing a computer program, wherein the computer program is executed by a processor to implement the intelligent safety monitoring method according to any one of claim 9.
